(19) United States
(12) Patent Application Publication
(10) Pub. No.: US 2008/0189141 A1
(43) Pub. Date: Aug. 7, 2008

(54) Method of Managing the Business of a Health Insurance Plan and a System Therefor

(76) Inventor: Adrian Gore, Houghton Estate (ZA)

Correspondence Address: MARSHALL & MELHORN, LLC, FOUR SEAGATE - EIGHTH FLOOR, TOLEDO, OH, 43604, US

(21) Appl. No.: 11/794,830

(22) PCT Filed: Dec. 21, 2005
(86) PCT No.: PCT/IB05/03842

§ 371 Date: Jan. 22, 2008

Related U.S. Application Data
(60) Provisional application No. 60/642,452, filed on Jan. 7, 2005.

(51) Int. Cl. G06Q 50/00; G06Q 40/00

(52) U.S. Cl. 705/4; 705/2

(57) ABSTRACT

A method of managing the business of a health insurance plan, wherein the provider of such health insurance plan undertakes liability in return for a premium or contribution, and insures members who pay such premiums or make such contributions for covered health services or manages an account from which covered health care expenses are paid. The method includes calculating an amount of expenditure of a member using a credit or debit card issued to the member and increasing the amount of funds available to a member in a medical savings account to be used by the member to pay for health services or increasing the amount of liability the health insurance plan undertakes. The amount of the increase is a percentage of the amount of expenditure of the member using the credit or debit card issued to the member.

### BACKGROUND OF THE INVENTION

The present invention relates to a method of managing the business of a health insurance plan and a system therefor.

A traditional health insurance plan operates with the insurer of the health plan undertaking liability in return for a premium or contribution and insures members who pay such premiums or make such contributions (or for whom such premium or contribution is paid by the member's employer) for covered health services or manages an account (contributed to by the member or the member's employer) from which covered health care expenses are paid.

The aim of these types of health insurance plans is to afford members access to the best health services which they may otherwise not be able to afford.

From the member's point of view, any incentive that helps the member manage her/his medical expenses more carefully and allows him/her to more easily afford these expenses is beneficial particularly in a rapidly developing consumer driven healthcare environment.

The present invention seeks to address these incentives.

### SUMMARY

According to one example embodiment there is provided, in a method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
calculating an amount of expenditure of a member using a credit or debit card issued to the member; and
increasing the amount of funds available to a member in a medical savings account to be used by the member to pay for health services, wherein the amount of the increase is a percentage of the amount of expenditure of the member using the credit or debit card issued to the member.

The method may further include calculating a number of points earned by the member in an incentive programme operated by the health insurer or third party administrator of the health insurance plan, wherein the percentage used to determine the amount of the increase of the funds in the medical savings account is determined based on the number of points earned in the incentive programme.

According to another example embodiment there is further provided, in a method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
calculating an amount of expenditure of a member using a credit or debit card issued to the member; and
increasing the amount of liability the health insurance plan undertakes, wherein the amount of the increase is a percentage of the amount of expenditure of the member using the credit or debit card issued to the member.

The method may further include calculating a number of points earned by the member in an incentive programme operated by the health insurer or third party administrator of the health insurance plan, wherein the percentage used to determine the amount of the increase of the funds in the medical savings account is determined based on the number of points earned in the incentive programme.

According to another example embodiment there is further provided an electronic system for managing the business of a health insurance plan includes:
a calculating module to calculate an amount of expenditure of a member using a credit or debit card issued to the member; and
a funds allocation module to increase the amount of funds available to a member in a medical savings account to be used by the member to pay for health services, wherein the amount of the increase is a percentage of the amount of expenditure of the member using the credit or debit card issued to the member.

The system may include an incentive scheme points calculating module to calculate a number of points earned by the member in an incentive programme operated by the health insurer or third party administrator of the health insurance plan, wherein the percentage used to determine the amount of the increase of the funds in the medical savings account is determined based on the number of points earned in the incentive programme.

According to another example embodiment there is further provided an electronic system for managing the business of a health insurance plan includes:
a calculating module to calculate an amount of expenditure of a member using a credit or debit card issued to the member; and
a funds allocation module to increase the amount of liability the health insurance plan undertakes, wherein the amount of the increase is a percentage of the amount of expenditure of the member using the credit or debit card issued to the member.

The system may include an incentive scheme points calculating module to calculate a number of points earned by the member in an incentive programme operated by the health insurer or third party administrator of the health insurance plan, wherein the percentage used to determine the amount of the increase of the funds in the medical savings account is determined based on the number of points earned in the incentive programme.

### BRIEF DESCRIPTION OF THE DRAWINGS

FIG. 1 is a flow chart illustrating the methodology of an example embodiment;

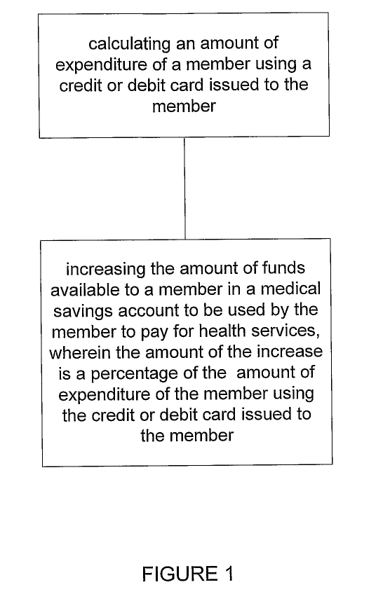

FIG. 2 is a flow chart illustrating the methodology of another example embodiment; and

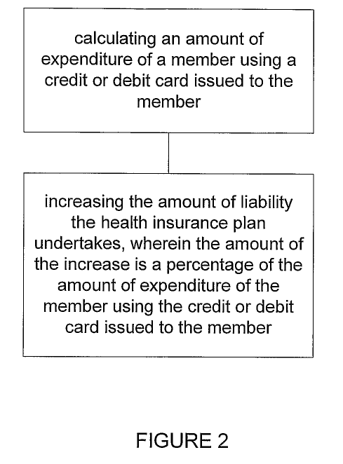

FIG. 3 is a block diagram illustrating an example system to implement the methodologies described herein.

### DESCRIPTION OF EMBODIMENTS

The invention finds application in the field of managing the business and operation of a health insurance plan. Typically, the insurer of such health insurance plans undertakes liability in return for a premium or contribution, and insures members who pay such premiums or make such contributions (or for whom such premium or contribution is paid by the member's employer) for covered health services or manages a personal medical fund or any other similar fund governed by respective healthcare and tax legislation (contributed to by the member or the member's employer) from which covered health care expenses are paid.

In certain countries, such health plans are referred to as medical schemes or medical aid schemes.

There are various models of health plans. For example, in one model the health insurer pays for all of the member's health services in particular agreed categories up to a predetermined limit. This predetermined limit is the limit of the health insurer's liability.

In an alternative model, a member has a personal medical fund or medical savings account or any other similar fund governed by respective healthcare and tax legislation which is managed by the health insurer or third party administrator of the health plan, but which the member and/or the member's employer funds. Any health related claims made to the health insurer are then paid by the health insurer or third party administrator from this personal medical fund up to a predetermined amount. Only after the predetermined amount does the health insurer incur liability and pay for the covered health related costs up to another predetermined amount.

In this method, the member typically pays to the health insurer an amount comprised of a risk premium portion in return for which the insurer undertakes liability for covered health services and a fund portion which is credited to the balance of the member's personal medical fund or any other similar fund governed by respective healthcare and tax legislation. It is this fund portion which the insurer or third party administrator will first use to pay for certain itemised covered health related costs incurred by the member.

The present invention finds application in both of these models, for example, as well as in other models of health plans which are used.

According to the present invention, the amount of expenditure made by the member on a debit or credit card issued to the member is calculated. The credit or debit card could be a debit or credit card of a third party financial institution that may or may not be branded by the health insurer. Alternatively, the credit or debit card could be issued by the health insurer itself.

Based on the calculated expenditure amount of the member using the credit or debit card issued to the member, either the amount of liability the health plan undertakes on behalf of the member is increased or the amount of funds available in the personal medical fund is increased. The amount is typically calculated as a percentage of the total spent on the credit or debit card in a given period.

The method may further include calculating a number of points earned by the member in an incentive program operated by the health insurer or third party administrator of the health insurance plan, wherein the percentage used to determine the increase in the liability of the health insurance plan or the increase in the funds in the Personal Medical Fund is determined based on the number of points earned in the incentive program.

An example of such an incentive program is presently managed by the applicant which manages a traditional indemnity health insurance plan together with their so-called Vitality™ program disclosed in the applicant's co-pending U.S. patent publication Ser. No. 09/982,274, the contents of which are incorporated herein by reference.

The Vitality program rewards members for utilizing approved health related facilities and/or services. For example, members are rewarded for utilizing gymnasiums, Smoke Enders™ and Weighless™.

Members are rewarded by a points allocation system and depending on the total number of points allocated to a member, they fall within one of four statuses. In the implementation of the Vitality program, these statuses have been named in ascending order of value, blue, bronze, silver and gold. All members are placed initially in the blue status. Once a member has accumulated a predetermined number of points, his/her Vitality status is upgraded to the next appropriate level.

With the above in mind, the following is an example of a table used to calculate the percentage.

| Vitality | Percentage of credit/ |
|---|---|
| Statuses | debit card spend |
| Blue | 2% |
| Bronze | 5% |
| Silver | 10% |
| Gold | 20% |

These percentages could obviously vary depending on a number of operational, competitive and commercial factors.

Using the above in an example leads to the following:

| Amount spent on Debit | | Amount credited to |
|---|---|---|
| or Credit card | Vitality Status | personal medical fund |
| US $1,000 | Blue | US $20 |
| US $1,000 | Bronze | US $50 |
| US $1,000 | Silver | US $100 |
| US $1,000 | Gold | US $200 |

It will be appreciated that by simply making purchases on their credit card or debit cards, members make their health care more affordable by earning themselves a credit on their Personal Medical Fund or any other similar fund governed by respective healthcare and tax legislation or an increase in the liability of their health insurers.

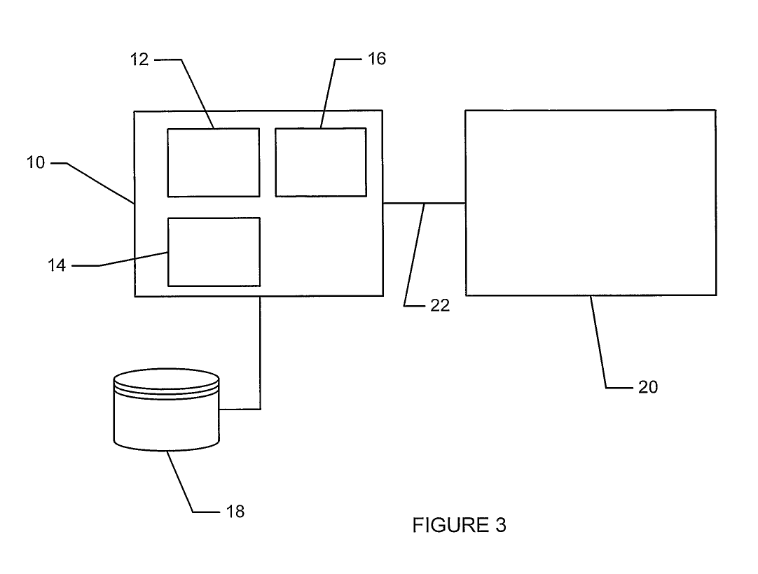

FIG. 3 illustrates an exemplary system for implementing the above methodologies.

A server 10 is typically operated by the managers of a health insurance plan. The server includes a calculating module 12 to calculate an amount of expenditure of a member using a credit or debit card issued to the member.

The server also includes a funds allocation module 14 to increase the amount of funds available to a member in a medical savings account to be used by the member to pay for health services or to increase the amount of liability the health insurance plan undertakes on behalf of the member.

As has been described above, the amount of the increase is a percentage of the amount of expenditure of the member using the credit or debit card issued to the member.

An incentive scheme points calculating module 16 is used to calculate a number of points earned by the member in an incentive programme operated by the health insurer or third party administrator of the health insurance plan, wherein the percentage used to determine the amount of the increase of the funds in the medical savings account is determined based on the number of points earned in the incentive programme.

The system may include a database 18 for storing information to allow the methodologies to be implemented.

Further, a server 20 of a financial institution is connected via a communications network 22 to the server 10. This may be necessary where the debit or credit card of the member is a debit or credit card of a third party financial institution.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

1. A method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
calculating an amount of expenditure of a member using a credit or debit card issued to the member; and
increasing the amount of funds available to a member in a medical savings account to be used by the member to pay for health services, wherein the amount of the increase is a percentage of the amount of expenditure of the member using the credit or debit card issued to the member.

2. A method according to claim 1, the method including calculating a number of points earned by the member in an incentive programme operated by the health insurer or third party administrator of the health insurance plan, wherein the percentage used to determine the amount of the increase of the funds in the medical savings account is determined based on the number of points earned in the incentive programme.

3. A method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
calculating an amount of expenditure of a member using a credit or debit card issued to the member; and
increasing the amount of liability the health insurance plan undertakes, wherein the amount of the increase is a percentage of the amount of expenditure of the member using the credit or debit card issued to the member.

4. A method according to claim 3, the method including calculating a number of points earned by the member in an incentive programme operated by the health insurer or third party administrator of the health insurance plan, wherein the percentage used to determine the amount of the increase of the funds in the medical savings account is determined based on the number of points earned in the incentive programme.

5. An electronic system for managing the business of a health insurance plan includes:
a calculating module to calculate an amount of expenditure of a member using a credit or debit card issued to the member; and
a funds allocation module to increase the amount of funds available to a member in a medical savings account to be used by the member to pay for health services, wherein the amount of the increase is a percentage of the amount of expenditure of the member using the credit or debit card issued to the member.

6. An electronic system according to claim 5, the system including an incentive scheme points calculating module to calculate a number of points earned by the member in an incentive programme operated by the health insurer or third party administrator of the health insurance plan, wherein the percentage used to determine the amount of the increase of the funds in the medical savings account is determined based on the number of points earned in the incentive programme.

7. An electronic system for managing the business of a health insurance plan includes:
a calculating module to calculate an amount of expenditure of a member using a credit or debit card issued to the member; and
a funds allocation module to increase the amount of liability the health insurance plan undertakes, wherein the amount of the increase is a percentage of the amount of expenditure of the member using the credit or debit card issued to the member.

8. An electronic system according to claim 7, the system including an incentive scheme points calculating module to calculate a number of points earned by the member in an incentive programme operated by the health insurer or third party administrator of the health insurance plan, wherein the percentage used to determine the amount of the increase of the funds in the medical savings account is determined based on the number of points earned in the incentive programme.

9. A machine-readable medium embodying instructions which, when executed by a machine, cause the machine to perform a method including:
calculating an amount of expenditure of a member using a credit or debit card issued to the member; and
increasing the amount of funds available to a member in a medical savings account to be used by the member to pay for health services, wherein the amount of the increase is a percentage of the amount of expenditure of the member using the credit or debit card issued to the member.
